(19) United States
(12) Patent Application Publication
(10) Pub. No.: US 2006/0171038 A1
(43) Pub. Date: Aug. 3, 2006

(54) Digital image zoom system

(75) Inventors: Po-Chih Hung, Taipei Hsien (TW); Ying-Ming Hwang, Taipei Hsien (TW); Yung-Che Chang, Taipei Hsien (TW)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: AVERMEDIA TECHNOLOGIES, INC.

(21) Appl. No.: 11/325,496

(22) Filed: Jan. 5, 2006

(30) Foreign Application Priority Data
Feb. 1, 2005 (TW) 94103121
Jun. 24, 2005 (TW) 94121278

(51) Int. Cl. G02B 15/14

(52) U.S. Cl. 359/691

(57) ABSTRACT

The present invention relates to a digital image zoom system. The digital image zoom system includes an image sensor, an A/D converter and an image processor. The image sensor senses the object images, wherein the sensing capacity of the image sensor is larger than the resolution of the display. The A/D converter converts the object images into digital images. The image processor retrieves a zoom image from the digital images and produces the zoom image having different sensing resolution according to the sensing capacity of the image sensor.

### RELATED APPLICATIONS

The present application is based on, and claims priorities from, Taiwan Application Serial Number 94103121, filed Feb. 1, 2005; and Taiwan Application Serial Number 94121278, filed Jun. 24, 2005, the disclosure of which is hereby incorporated by reference herein in its entirety.

### BACKGROUND OF THE INVENTION

1. Field of Invention

The invention relates to a digital image zoom system and, in particular, to a digital image zoom system for a document camera.

2. Related Art

The document camera is an image capture device that captures the image of an object immediately and sends the image to a projector for display. The document camera is often seen in conference presentations for the user to project an object image in real time.

FIG. 1 shows a document camera 100 that has a lens 110, a circuit 120, and a support 130. The lens 110 is used to form an image of the object 140 to be displayed. The object image is processed by the circuit 120 and, through the circuit inside the support 130, is transmitted to a projector 150 for presentation on a display 160.

The normal document camera uses a lens with a fixed focal length. Therefore, it is not possible to zoom the image in and out by changing the focal length. In this case, a common practice is to reprocess the image data sent from the lens of the image sensor by interpolation. The reprocessed image data are then used to produce the desired zoom effect.

FIG. 2 shows how the image captured by the document camera in the prior art is zoomed. As shown in the drawing, the image sensor 204 senses the object image captured by a lens with a fixed focal length. The image sensor 204 has a specific sensing capacity that is the same as the resolution of the display 206. In FIG. 2, the resolution of the display 206 is 1024×768 pixels. The sensing capacity of the image sensor 204 is also 1024×768 pixels. Therefore, each pixel detected by the image sensor 204 is shown on the display 206.

If one wants to locally expand the block M1 of size 512×384 pixels in the image sensor 204, there is problem because the resolution of the display 206 is 1024×768 pixels, greater than the number of pixels in the block M1. Therefore, the pixels in the block M1 cannot fill the display 206. In this case, one needs to utilize mathematical algorithms to generate the insufficient pixels by interpolation in order to magnify the block M1.

However, this method of zooming images by interpolation has several drawbacks. First, the data in the image obtained by interpolation are interpreted instead of being original optical image data. This method is very likely to produce an aliasing phenomenon, resulting in zigzag patterns and distortion in the zoomed image. Furthermore, the zoomed image by interpolation has discontinuities, so that it does not look like the original object. To solve the aliasing and discontinuity phenomena when zooming an image, one relies on an optical zoom lens for the image sensor to obtain the actual optical image data without further interpretation. However, using an optical zoom lens requires an accompanying driving motor. This greatly increases the production cost of the document camera.

There are generally two types of digital cameras in the consumer market now. One type of digital camera has a lens with fixed focal length. The other type of digital camera has a zoom lens.

For the lens with fixed focal length, the zoomed image does not distort when a still image is reduced or expanded in resolution, or a motion image is reduced in resolution. However, the interpolation method is used when a motion image is expanded in resolution, causing image distortion.

For the zoom lens, a still or motion image does not distort when zooming in or out. The main drawback of the zoom lens is the cost. Moreover, when a triple (3×) magnification zoom lens is used in the operation of zooming in, for example, the maximum undistorted image size is 300% of the original image size. To obtain an undistorted 4×-scaled image, a 4× or higher magnification zoom lens must be used.

It is thus imperative to provide an image zoom system for the document camera so that the image captured can be readily zoomed without using either an expensive zoom lens or the interpolation method. Moreover, the aliasing phenomenon must be avoided during this zooming process.

### SUMMARY OF THE INVENTION

An object of the invention is to provide a digital image zoom system for a document camera that can zoom an object image captured by the document camera without interpolation and present it on a display.

Another object of the invention is to provide a document camera with a digital image zoom system that avoids using the interpolation method such that the object image captured by the document camera can be zoomed and displayed.

In accord with the above-mentioned objects, the disclosed digital image zoom system is used in a document camera to zoom a captured object image and to show the image on a display. The digital image zoom system includes an image sensor, an A/D converter, an image processor, and a video converter. The image sensor senses an object image, wherein the sensing capacity of the image sensor is larger than the resolution of the display. The AID converter converts the object image into a digital image. The image processor retrieves a zoom image from the digital image. The video converter converts the zoom image.

According to another object of the invention, a document camera that can zoom a captured object image without employing the interpolation method and displays it is disclosed, wherein the document camera has a lens, an image sensor, an A/D converter, an image processor, a video converter, and a support. The lens is used to capture the object image. The image sensor senses the image captured by the lens, where the sensing capacity of the image sensor is larger than the resolution of the display. The A/D converter converts the object image into a digital image. The image processor is used to extract a zoom image from the digital image. The video converter converts the zoom image. The zoom image is then transmitted via a circuit in the support to the display.

According to yet another object of the invention, the disclosed digital image zoom system is used in a document camera to zoom a captured object image and to show the image on a display, wherein the digital image zoom system includes an image sensor, an A/D converter and an image processor. The image sensor senses an object image, wherein the sensing resolution of the image sensor is larger than the resolution of the display. The A/D converter converts the object image into a digital image. The image processor retrieves a zoom image from the digital image, wherein the image processor produces a zoom image with different resolution according to the sensing resolution of the image sensor.

According to still another object of the invention, the disclosed digital image zoom system is used in a camera to expand a captured motion object image and to show the image on a display, wherein the digital image zoom system includes a lens, an image sensor, an A/D converter and an image processor. The lens is used to capture a motion object image. The image sensor senses the motion object image, wherein the sensing resolution of the image sensor is larger than the resolution of the display. The A/D converter converts the motion object image into a digital image. The image processor retrieves an expanded motion image from the digital image, wherein the image processor produces the expanded motion image with different resolution according to the sensing resolution of the image sensor.

The disclosed digital image zoom system does not require an expensive zoom lens. Through the combination of an image sensor and an image processor, the zoom digital image can be readily obtained without significantly increasing the production cost. It is particularly suitable for the existing document camera that uses a lens with a fixed focal length. Moreover, the disclosed digital image zoom system has an image sensor with a sensing resolution larger than the resolution of the display. When zooming a digital image, the original image data can be presented with different resolutions without interpolation, thus avoiding the aliasing and discontinuity phenomena.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a side view of the document camera in the prior art;

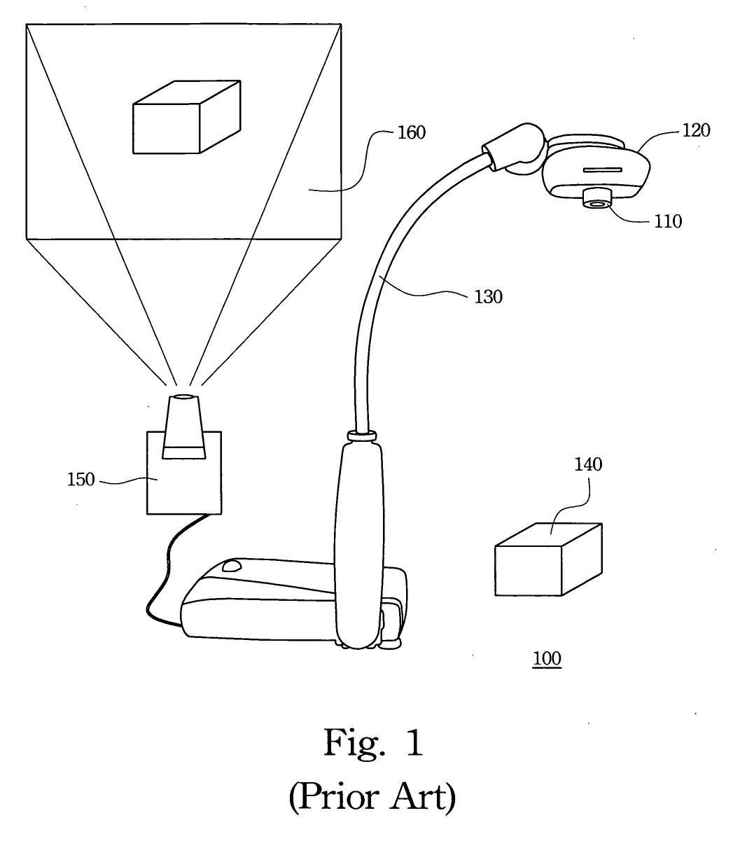

FIG. 2 is a schematic view of using a conventional document camera to zoom a digital image;

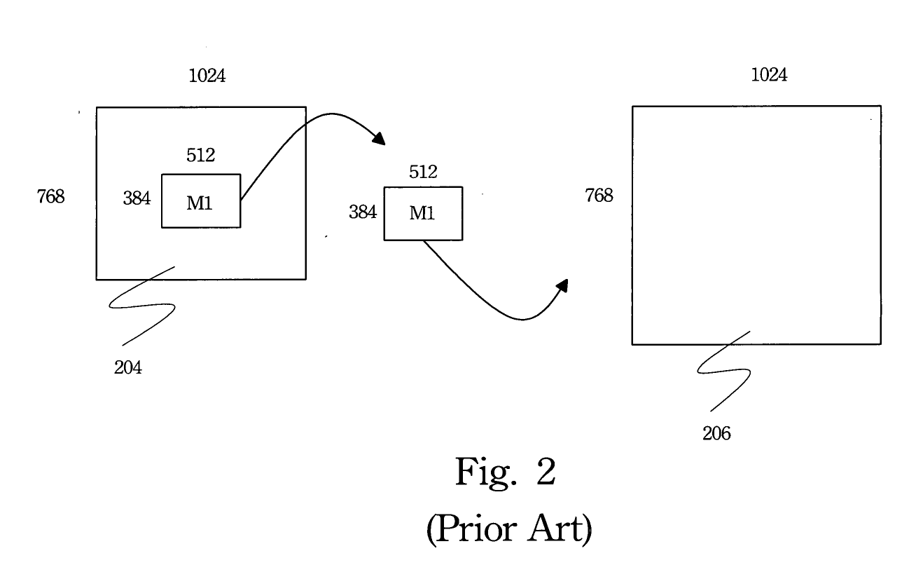

FIG. 3 is a block diagram of the disclosed digital image zoom system;

FIG. 4 is a block diagram of the disclosed digital image zoom system according to an embodiment of the invention;

FIG. 5 is a schematic view of using the document camera to zoom a digital image according to a preferred embodiment of the invention;

FIG. 6 is a side view of the document camera according to a preferred embodiment of the invention; and

FIG. 7 is a block diagram of the digital image zoom system in the document camera according to a preferred embodiment of the invention.

### DETAILED DESCRIPTION OF THE PREFERRED EMBODIMENT

According to the disclosed digital image zoom system, the sensing capacity (sensing resolution) of the image sensor is greater than the resolution of the display. When zooming an image, no interpolation is required to process the image. This avoids the aliasing and discontinuity phenomena caused by interpolation.

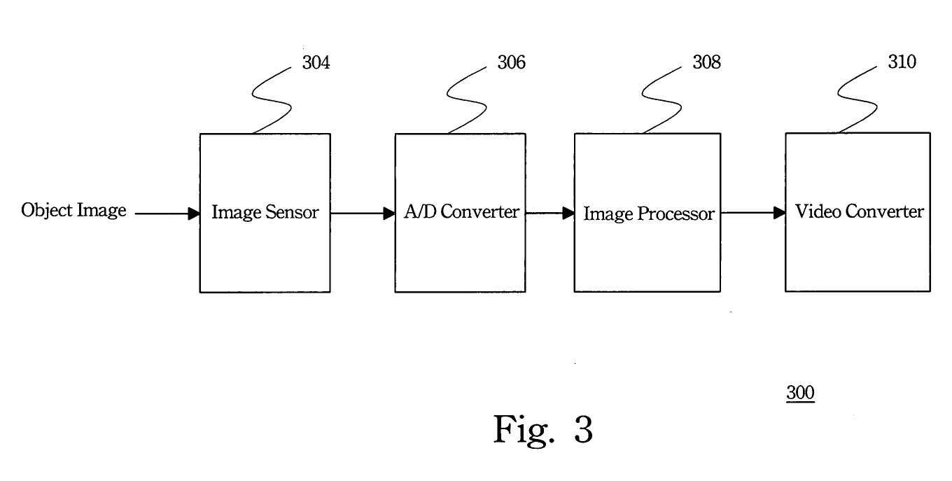

As shown in FIG. 3, the disclosed digital image zoom system 300 is used for a document camera to zoom an object image captured by the document camera and to display it on a display. The digital image zoom system 300 has an image sensor 304, an A/D converter 306, an image processor 308, and a video converter 310. The image sensor 304 is used to sense an object image formed by a lens. The sensing capacity of the image sensor 304 is greater than the resolution of the display to be used. The A/D converter 306 is used to convert the object image into a digital image. The image processor 308 extracts a required zoom image from the digital image, wherein the zooming method of the zoom image uses a high resolution of the image sensor 304, which is greater than the resolution of the display, to produce a sub-sampling image with different resolution. According to the zooming method of the present invention, different resolutions of the sub-sampling images are consistent with the zoom image produced by a traditional optical zoom lens. The video converter 310 (or video transformer) is used to convert (or transform) the zoom image and display it on a display. The display format of the converted (or transformed) zoom image is, for example, NTSC, PAL, YPbPr, RGB, CVBS, S-Video, DVI, HDMI or the like.

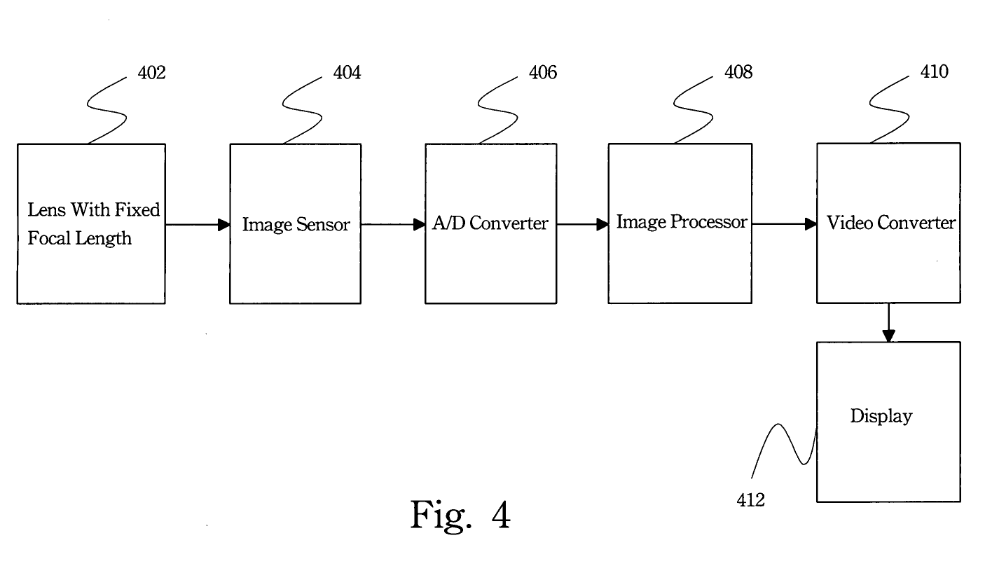

According to the system block diagram in FIG. 4, the lens 402 with a fixed focal length forms an image of the object. The image is sensed by the image sensor 404. The image sensor 404 can be a charge-coupled device (CCD) or a complementary metal oxide semiconductor (CMOS), with a sensing capacity such as 4096×3072 pixels. The object image is then sent to the A/D converter 406 to be converted into a digital image. The image processor 408 extracts a required zoom image from the digital image. The zoom image is transmitted to the video converter 410 for converting or transforming. Finally, it is displayed on a display 412 with a resolution of 1024×768 pixels. For example, when the lens 402 has a 3× magnification and the image sensor 404 has a 4× magnification, a 12× magnification object image without distortion on a display 412 can be obtained. In a preferred embodiment, the digital zoom system of the present invention is used to magnify a motion image.

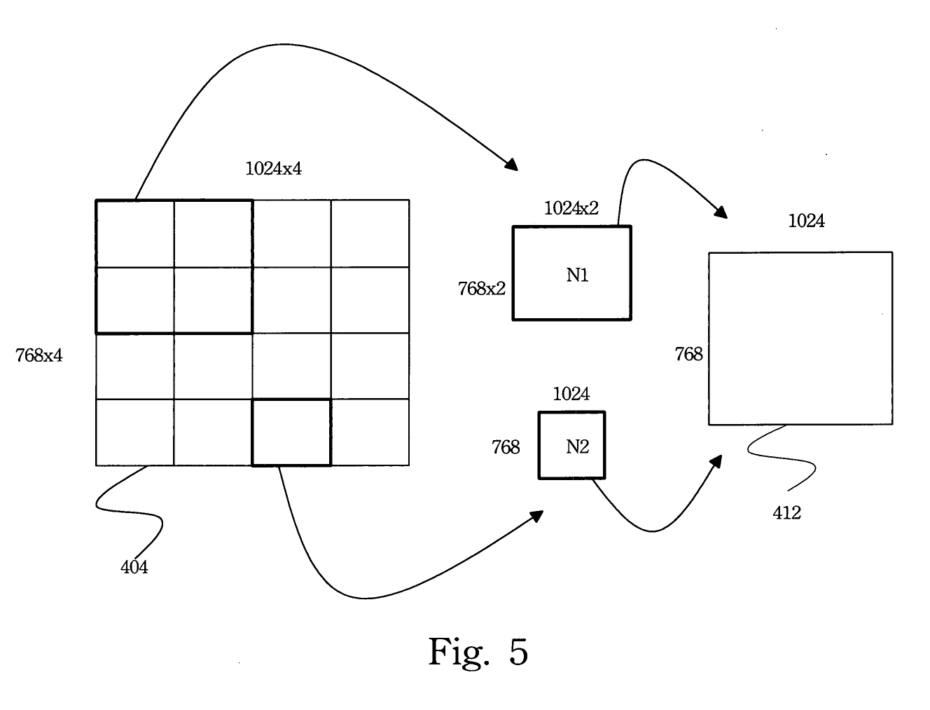

FIG. 5 further explains how the required zoom image using the image processor 408 is extracted. The sensing capacity of the image sensor 404 is 4096×3072 pixels, which is 16 times the display 412 whose resolution is 1024×768 pixels (or 4 times per dimension). The image sensor 404 is divided into 16 blocks for explanation, each of which has 1024×768 pixels. Referring to the drawing, suppose one selects the block N1 for magnification. Since N1 has 2048×1536 pixels, larger than the resolution of the display 412, the image processor 408 directly selects 1024×768 pixels from the 2048×1536 pixels of the block N1 and sends them to the display 412. As the sensing capacity of the image sensor 404 is greater than the resolution of the display 412, the image processor 408 can directly select image data that fit the resolution of the display 412 from the image sensor 404, without reprocessing the image data by interpolation. Therefore, the magnified image does not have aliasing. In the prior art, the sensing capacity of the image sensor 404 is smaller than the resolution of the display 412. Therefore, one has to use interpolation to generate extra pixels, resulting in aliasing.

Likewise, suppose one selects to zoom the block N2. Since it has 1024×768 pixels, exactly the same as the resolution of the display 412, the image processor 408 directly extracts these pixels and displays them on the display 412.

When the sensing capacity of the image sensor is larger than the resolution of the display, it is preferable that the sensing capacity is an integer multiple of the resolution, but is not limited to an integer multiple. In this case, the image processor can readily extract the required zoom image from the object image captured by the image sensor, without using the interpolation method.

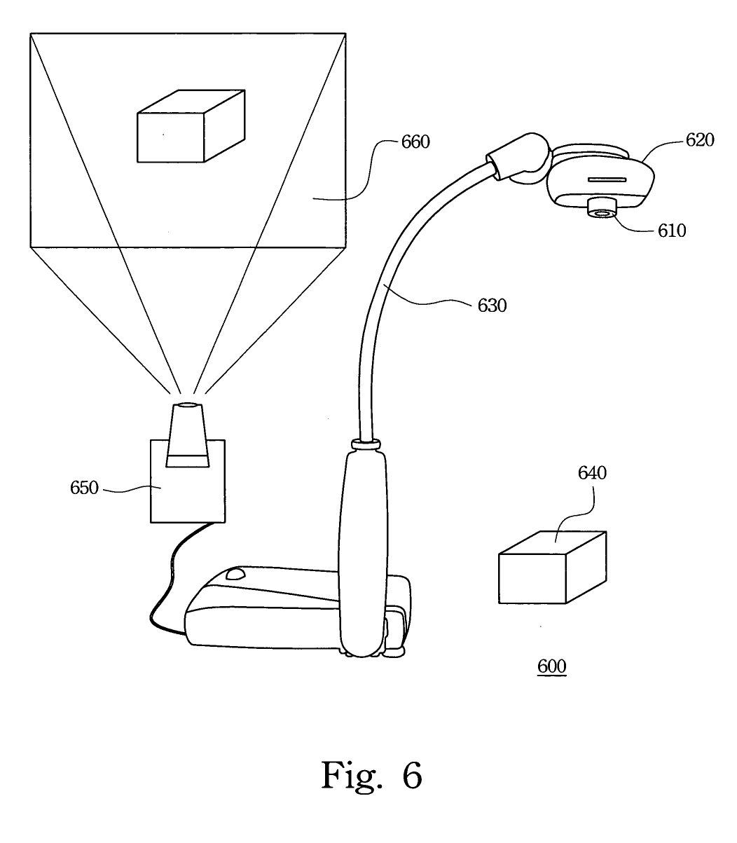

As shown in FIG. 6, the disclosed document camera 600 has a lens 610, a digital image zoom system 620, and a support 630. The lens 610 is used to form an object image for the object 640 to be displayed. The object image formed by the lens 610 is transmitted to the digital image zoom system 620 for image zooming. Finally, the zoom image is transmitted via a circuit inside the support 630 to a projector 650 for display on the display 660.

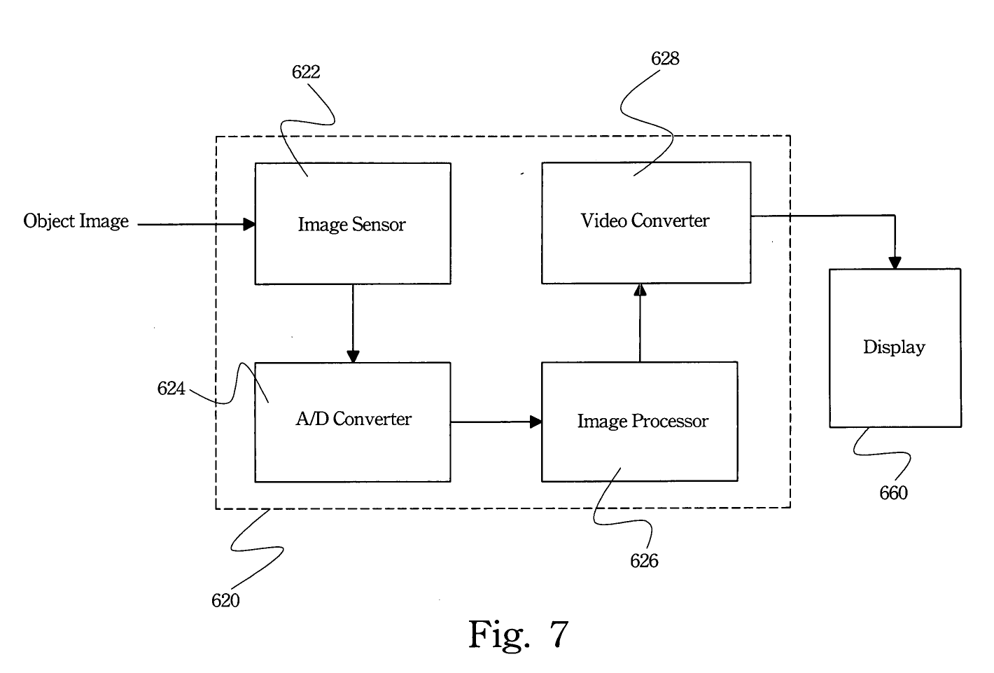

FIG. 7 further illustrates the digital image zoom system 620. The digital image zoom system 620 has an image sensor 622, an A/D converter 624, an image processor 626, and a video converter 628. The image sensor 622 is used to sense the object image formed by the lens 610. The sensing capacity of the image sensor 622 is larger than the resolution of the display 660. The A/D converter 624 converts the object image into a digital image. The image processor 626 extracts a required zoom image from the digital image. The zooming method of the zoom image uses a high resolution of the image sensor 622, which is greater than the resolution of the display 660, to produce a sub-sampling image with different resolution. The sub-sampling image has same display effect to a zoom image produced by an optical zoom lens, but with lower cost. The video converter 628 converts or transforms the zoom image. The converted zoom image is then sent via the circuit inside the support 630 to the display 660.

It is noted that, in the aforementioned preferred embodiments of the present invention, as described in FIG. 3, FIG. 4 and FIG. 7, the digital image zoom system 620 (as in FIG. 7) can be used in a document camera 600 of FIG. 6. Nevertheless, a camera of a general surveillance system can also be used. Furthermore, the video converter 826 is an option of the digital image zoom system 620. For example, the video converter 826 can be installed in the display 660 instead of the digital image zoom system 620. That is, the image processor 626 extracts a required zoom image from the AID converter 624. The zoom image is converted or transformed via the video converter 826 in the display 660 and finally displays on the display 660.

The disclosed digital image zoom system does not require an expensive zoom lens. Through the combination of an image sensor and an image processor, the zoom digital image can readily obtain the same result as that produced by an optical zoom lens without significantly increasing the production cost, such as by expansion of a motion image. It is particularly suitable for the existing document camera that uses a lens with a fixed focal length. Moreover, the disclosed digital image zoom system has an image sensor with a sensing capacity larger than the resolution of the display. When zooming a digital image, the original image data can be presented without interpolation, thus avoiding the aliasing and discontinuity phenomena.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A digital image zoom system for a document camera to zoom an object image captured by the document camera and to show it on a display, the digital image zoom system comprising:
an image sensor for sensing the object image and with a sensing capacity larger than a resolution of the display;
an A/D converter for converting the object image into a digital image;
an image processor for extracting a zoom image from the digital image; and
a video converter for converting the zoom image.

2. The digital image zoom system of claim 1, wherein the image sensor is comprised of charge-coupled devices (CCDs).

3. The digital image zoom system of claim 1, wherein the image sensor is comprised of complementary metal oxide semiconductor (CMOS).

4. The digital image zoom system of claim 1, wherein the sensing capacity of the image sensor is an integer multiple of the resolution of the display.

5. The digital image zoom system of claim 1, wherein the object image is captured by a lens of the document camera.

6. A document camera, comprising:
a lens for capturing an object image;
an image sensor for sensing the object image and with a sensing capacity larger than a resolution of the display;
an A/D converter for converting the object image into a digital image;
an image processor for extracting a zoom image from the digital image;
a video converter for converting the zoom image; and
a support with a transmission circuit for transmitting the converted zoom image to the display for display.

7. The document camera of claim 6, wherein the image sensor is comprised of charge-coupled devices (CCDs).

8. The document camera of claim 6, wherein the image sensor is comprised of complementary metal oxide semiconductor (CMOS).

9. The document camera of claim 6, wherein the sensing capacity of the image sensor is an integer multiple of the resolution of the display.

10. A digital image zoom system for a document camera to zoom an object image captured by the document camera and to show it on a display, the digital image zoom system comprising:
an image sensor for sensing the object image and with a sensing resolution larger than a resolution of the display;
an A/D converter for converting the object image into a digital image; and
an image processor for extracting a first zoom image from the digital image, wherein the image processor produces a second zoom image with a different resolution than that of the first zoom image according to the resolution of the image sensor.

11. The digital image zoom system of claim 10, wherein the display further comprises a video converter for converting the second zoom image and displaying it on the display.

12. The digital image zoom system of claim 10, wherein the image sensor is comprised of charge-coupled devices (CCDs).

13. The digital image zoom system of claim 10, wherein the image sensor is comprised of complementary metal oxide semiconductor (CMOS).

14. The digital image zoom system of claim 10, wherein the sensing resolution of the image sensor is an integer multiple of the resolution of the display.

15. The digital image zoom system of claim 10, wherein the object image is captured by a lens of the document camera.

16. The digital image zoom system of claim 15, wherein the lens is a fixed focal length lens.

17. A digital image zoom system for a document camera to expand a motion object image captured by the document camera and to show it on a display, the digital image zoom system comprising:
a lens for capturing the motion object image;
an image sensor for sensing the motion object image and with a sensing resolution larger than a resolution of the display;
an A/D converter for converting the motion object image into a digital image; and
an image processor for extracting a first expanded motion image from the digital image, the image processor produces a second expanded motion image with a different resolution than that of the first expanded motion image according to the resolution of the image sensor.

18. The digital image zoom system of claim 17, wherein the sensing resolution of the image sensor is an integer multiple or non-integer multiple of the resolution of the display.

19. The digital image zoom system of claim 17, further comprising a video converter for converting the second expanded motion image and displaying it on the display.

20. The digital image zoom system of claim 17, wherein the lens comprises a fixed focal length lens or a zoom lens.
